(19) United States
(12) Patent Application Publication
(10) Pub. No.: US 2014/0261797 A1
(43) Pub. Date: Sep. 18, 2014

(54) TUBE FITTING HAVING INTEGRATED TEE FITTING

(71) Applicant: UNITED TECHNOLOGIES CORPORATION, Hartford, CT (US)

(72) Inventors: Raphael Lior, Brookline, MA (US); Steven Dill, Glastonbury, CT (US); Nelson A. Martinez, Vega Alta (PR)

(73) Assignee: UNITED TECHNOLOGIES CORPORATION, Hartford, CT (US)

(21) Appl. No.: 14/203,623

(22) Filed: Mar. 11, 2014

Related U.S. Application Data
(60) Provisional application No. 61/782,510, filed on Mar. 14, 2013.

(51) Int. Cl. F16L 41/02

(52) U.S. Cl. CPC F16L 41/021
USPC 137/561 A; 285/133.11

(57) ABSTRACT

A tube fitting according to an exemplary aspect of the present disclosure includes, among other things, a housing and a tee fitting integrated with the housing to form a monolithic structure.

### CROSS REFERENCE TO RELATED APPLICATIONS

This application claims priority to U.S. Provisional Application No. 61/782,510, which was filed on Mar. 14, 2013.

### BACKGROUND

This disclosure relates generally to a tubing system, and more particularly, but not exclusively, to a tube fitting having an integrated tee fitting.

Gas turbine engines typically include at least a compressor section, a combustor section and a turbine section. During operation, air is pressurized in the compressor section and is mixed with fuel and burned in the combustor section to generate hot combustion gases. The hot combustion gases are communicated through the turbine section which extracts energy from the hot combustion gases to power the compressor section and other gas turbine engine loads.

Gas turbine engines may include tubing systems for circulating fluids, such as airflow, fuel or lubricant, from one engine location to another engine location. Various tube fittings may be required to connect a plurality of tube portions that make up the tubing system.

### SUMMARY

A tube fitting according to an exemplary aspect of the present disclosure includes, among other things, a housing and a tee fitting integrated with the housing to form a monolithic structure.

In a further non-limiting embodiment of the foregoing tube fitting, the tee fitting includes at least a first tube fitting connection and a second tube fitting connection.

In a further non-limiting embodiment of either of the foregoing tube fittings, each of the first tube fitting connection and the second tube fitting connection defines a fluid passage for directing fluid through the tee fitting.

In a further non-limiting embodiment of any of the foregoing tube fittings, the housing defines a fluid passage that connects with the fluid passages of the first tube fitting connection and the second tube fitting connection.

In a further non-limiting embodiment of any of the foregoing tube fittings, a first tube portion is connected to the first tube fitting connection and a second tube portion is connected with the second tube fitting connection.

In a further non-limiting embodiment of any of the foregoing tube fittings, the first tube portion is larger than the second tube portion.

In a further non-limiting embodiment of any of the foregoing tube fittings, the first tube portion is brazed to the first tube fitting connection and the second tube portion is coupled to the second tube fitting connection with a B-nut connector.

In a further non-limiting embodiment of any of the foregoing tube fittings, the first tube fitting connection extends outward of the second tube fitting connection.

In a further non-limiting embodiment of any of the foregoing tube fittings, the housing includes an inner face and an outer face, and the tee fitting protrudes from the outer face.

In a further non-limiting embodiment of any of the foregoing tube fittings, the tube fitting comprises a seal disposed within a groove on the inner face.

A gas turbine engine according to an exemplary aspect of the present disclosure includes, among other things, a tubing system that circulates a fluid, a manifold in fluid communication with a portion of the tubing system and a tube fitting mounted to the manifold, the tube fitting including a housing and a tee fitting integrated with the housing to form a monolithic structure.

In a further non-limiting embodiment of the foregoing gas turbine engine, the tubing system circulates at least one of airflow, fuel and lubricant.

In a further non-limiting embodiment of either of the foregoing gas turbine engines, the tee fitting includes at least a first tube fitting connection and a second tube fitting connection.

In a further non-limiting embodiment of any of the foregoing gas turbine engines, the tubing system includes a first tube portion connected to the first tube fitting connection and a second tube portion connected with the second tube fitting connection.

In a further non-limiting embodiment of any of the foregoing gas turbine engines, the housing includes an inner face and an outer face, the inner face mounted to the manifold and the tee fitting protruding from the outer face.

A method of providing a tube fitting for connecting tubing according to another exemplary aspect of the present disclosure includes, among other things, integrating a housing and a tee fitting to provide a tube fitting having a monolithic structure.

In a further non-limiting embodiment of the foregoing method, the method includes mounting the tube fitting to a manifold of a tubing system.

In a further non-limiting embodiment of either of the foregoing methods, the method includes connecting at least two tube portions to the tube fitting.

In a further non-limiting embodiment of any of the foregoing methods, the method includes communicating fluid in either direction between the at least two tube portions, the tube fitting, and the manifold.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a schematic, cross-sectional view of a gas turbine engine.

FIG. 2 illustrates a tubing system of a gas turbine engine.

FIG. 3 illustrates part of a gas turbine engine tubing system.

FIGS. 4A, 4B and 4C illustrate an exemplary tube fitting that can be incorporated into a gas turbine engine tubing system.

### DETAILED DESCRIPTION

FIG. 1 schematically illustrates a gas turbine engine 20. The exemplary gas turbine engine 20 is a two-spool turbofan engine that generally incorporates a fan section 22, a compressor section 24, a combustor section 26 and a turbine section 28. Alternative engines might include an augmenter section (not shown) among other systems for features. The fan section 22 drives air along a bypass flow path B, while the compressor section 24 drives air along a core flow path C for compression and communication into the combustor section 26. The hot combustion gases generated in the combustor section 26 are expanded through the turbine section 28. Although depicted as a turbofan gas turbine engine in the disclosed non-limiting embodiment, it should be understood that the concepts described herein are not limited to turbofan engines and these teachings could extend to other types of engines, including but not limited to, three-spool engine architectures.

The gas turbine engine 20 generally includes a low speed spool 30 and a high speed spool 32 mounted for rotation about an engine centerline longitudinal axis A. The low speed spool 30 and the high speed spool 32 may be mounted relative to an engine static structure 33 via several bearing systems 31. It should be understood that other bearing systems 31 may alternatively or additionally be provided.

The low speed spool 30 generally includes an inner shaft 34 that interconnects a fan 36, a low pressure compressor 38 and a low pressure turbine 39. The inner shaft 34 can be connected to the fan 36 through a geared architecture 45 to drive the fan 36 at a lower speed than the low speed spool 30. The high speed spool 32 includes an outer shaft 35 that interconnects a high pressure compressor 37 and a high pressure turbine 40. In this embodiment, the inner shaft 34 and the outer shaft 35 are supported at various axial locations by bearing systems 31 positioned within the engine static structure 33.

A combustor 42 is arranged between the high pressure compressor 37 and the high pressure turbine 40. A mid-turbine frame 44 may be arranged generally between the high pressure turbine 40 and the low pressure turbine 39. The mid-turbine frame 44 can support one or more bearing systems 31 of the turbine section 28. The mid-turbine frame 44 may include one or more airfoils 46 that extend within the core flow path C.

The inner shaft 34 and the outer shaft 35 are concentric and rotate via the bearing systems 31 about the engine centerline longitudinal axis A, which is co-linear with their longitudinal axes. The core airflow is compressed by the low pressure compressor 38 and the high pressure compressor 37, is mixed with fuel and burned in the combustor 42, and is then expanded over the high pressure turbine 40 and the low pressure turbine 39. The high pressure turbine 40 and the low pressure turbine 39 rotationally drive the respective high speed spool 32 and the low speed spool 30 in response to the expansion.

The pressure ratio of the low pressure turbine 39 can be pressure measured prior to the inlet of the low pressure turbine 39 as related to the pressure at the outlet of the low pressure turbine 39 and prior to an exhaust nozzle of the gas turbine engine 20. In one non-limiting embodiment, the bypass ratio of the gas turbine engine 20 is greater than about ten (10:1), the fan diameter is significantly larger than that of the low pressure compressor 38, and the low pressure turbine 39 has a pressure ratio that is greater than about five (5:1). It should be understood, however, that the above parameters are only exemplary of one embodiment of a geared architecture engine and that the present disclosure is applicable to other gas turbine engines, including direct drive turbofans.

In this embodiment of the exemplary gas turbine engine 20, a significant amount of thrust is provided by the bypass flow path B due to the high bypass ratio. The fan section 22 of the gas turbine engine 20 is designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example gas turbine engine 20 is less than 1.45. Low Corrected Fan Tip Speed is the actual fan tip speed divided by an industry standard temperature correction of [(Tram ° R)/(518.7° R)]^{0.5}. The Low Corrected Fan Tip Speed according to one non-limiting embodiment of the example gas turbine engine 20 is less than about 1150 fps (351 m/s).

Each of the compressor section 24 and the turbine section 28 may include alternating rows of rotor assemblies and vane assemblies (shown schematically) that carry airfoils that extend into the core flow path C. For example, the rotor assemblies can carry a plurality of rotating blades 25, while each vane assembly can carry a plurality of vanes 27 that extend into the core flow path C. The blades 25 create or extract energy (in the form of pressure) from the core airflow that is communicated through the gas turbine engine 20 along the core flow path C. The vanes 27 direct the core airflow to the blades 25 to either add or extract energy.

FIG. 2 illustrates a tubing system 50 that can be incorporated into a gas turbine engine, such as the gas turbine engine 20 of FIG. 1. The tubing system 50 is configured to circulate a fluid, such as airflow, fuel or lubricant (i.e., oil), from one engine location to another engine location. For example, in one non-limiting embodiment, the tubing system 50 communicates oil from an oil tank (not shown in FIG. 2) to a bearing system of the gas turbine engine 20. The tubing system 50 can include a plurality of tube portions 52 that communicate fluids throughout the gas turbine engine 20. Some of the tube portions 52 may be connected via one or more tube fittings 54. An exemplary tube fitting 54 is described in detail with reference to FIGS. 3, 4A, 4B and 4C.

Referring to FIG. 3, a manifold 56 may be in fluid communication with the tubing system 50. In this disclosure, the term “manifold” generally refers to a chamber that branches into additional openings. The manifold 56 could be associated with a buffer system, a fuel system, or a lubricating system of the gas turbine engine 20, among other systems. Although only a single manifold 56 is illustrated in this embodiment, the tubing system 50 could include manifolds located throughout the gas turbine engine 20. The exemplary tube fitting 54 may be mounted to the manifold 56 to communicate fluid from one or more of the tube portions 52, through the tube fitting 54, and into the manifold 56 for communication to a desired end location.

Among other features, the tube fitting 54 of this disclosure includes an integrated tee fitting 60. The exemplary tube fitting 54 integrates a fitting and tee into one part, thereby increasing part clearances, improving tooling access to the tubing system, and providing weight and cost benefits as compared to prior art tube fittings.

FIGS. 4A, 4B and 4C illustrate one exemplary tube fitting 54 that can be incorporated into a tubing system, such as the tubing system 50 illustrated in FIGS. 2 and 3. In one embodiment, the tube fitting 54 includes a housing 58 and a tee fitting 60 formed integrally with the housing 58 to form a monolithic structure. Stated another way, the housing 58 and the tee fitting 60 embody an integrated, single piece structure that is without mechanical attachments, joints or seams.

The housing 58 of the tube fitting 54 may include a plurality of openings 71 that receive fasteners 73 for mounting the tube fitting 54, such as to a manifold (see manifold 56 of FIG. 3). The size and shape of the housing 58 is not intended to limit this disclosure. The housing 58 includes an inner face 74 and an outer face 76. In one embodiment, the inner face 74 faces toward the manifold 56 (see FIG. 3) and the tee fitting 60 is formed integrally with and protrudes outwardly from the outer face 76, which faces away from the manifold 56 when mounted. A seal 75 (see FIG. 4A) may be received within a groove 77 formed on the inner face 74 to seal the tube fitting 54 relative to the structure it is mounted to, such as the manifold 56 (see FIG. 3).

The tube fitting 54 may connect tube portions 52 of different sizes and can include at least a first tube fitting connection 62 and a second tube fitting connection 64 that connect to a first tube portion 52A and a second tube portion 52B, respectively. In this embodiment, the first tube portion 52A and the second tube portion 52B are different sizes (here, the tube portion 52A is larger than the tube portion 52B), although the tube portions 52A, 52B could also be the same size. The tube fitting 54 could also include any number of tube fitting connections for connecting to a plurality of tube portions 52.

The first tube fitting connection 62, the second tube fitting connection 64, and the housing 58 define fluid passages 70A, 70B and 72 (best illustrated in FIG. 4C) that extend through the tube fitting 54 for directing fluid F through the housing 58, into the tee fitting 60, and subsequently into the tube portions 52A, 52B (or vice versa). The fluid passage 72 extends through the housing 58 and fluidly connects with the fluid passages 70A, 70B inside of the tee fitting 60. In one embodiment, the fluid passages 70A and 72 are coaxial to one another and are transverse to the fluid passage 70B, although other configurations are also contemplated.

The tube portions 52A, 52B may be connected to the tube fitting 54 in a variety of ways. For example, in one non-limiting embodiment, the tube portion 52A is brazed to the first tube fitting connection 62, while the tube portion 52B is coupled to the second tube fitting connection 64 using a B-nut connector 80 and a ferrule 82 (see FIGS. 4A and 4B).

In one embodiment, the first tube fitting connection 62 includes a first portion P1 having a first diameter and a second portion P2 outward of the first portion P1 (see FIG. 4B) and having a second diameter that is smaller than the first diameter of the first portion P1. The first tube fitting connection 62 may also extend a greater distance from the outer face 76 of the housing 58 as compared to the second tube fitting connection 64. In this embodiment, the first portion P1 of the first tube fitting connection 62 and the second tube fitting connection 64 extend equidistantly from the outer face 76, whereas the second portion P2 of the first tube fitting connection extends outwardly of both the first portion P1 and the second tube fitting connection 64.

Although the different non-limiting embodiments are illustrated as having specific components, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A tube fitting, comprising:
a housing; and
a tee fitting integrated with said housing to form a monolithic structure.

2. The tube fitting as recited in claim 1, wherein said tee fitting includes at least a first tube fitting connection and a second tube fitting connection.

3. The tube fitting as recited in claim 2, wherein each of said first tube fitting connection and said second tube fitting connection defines a fluid passage for directing fluid through said tee fitting.

4. The tube fitting as recited in claim 3, wherein said housing defines a fluid passage that connects with said fluid passages of said first tube fitting connection and said second tube fitting connection.

5. The tube fitting as recited in claim 2, comprising a first tube portion connected to said first tube fitting connection and a second tube portion connected with said second tube fitting connection.

6. The tube fitting as recited in claim 5, wherein said first tube portion is larger than said second tube portion.

7. The tube fitting as recited in claim 5, wherein said first tube portion is brazed to said first tube fitting connection and said second tube portion is coupled to said second tube fitting connection with a B-nut connector.

8. The tube fitting as recited in claim 2, wherein said first tube fitting connection extends outward of said second tube fitting connection.

9. The tube fitting as recited in claim 1, wherein said housing includes an inner face and an outer face, and said tee fitting protrudes from said outer face.

10. The tube fitting as recited in claim 9, comprising a seal disposed within a groove on said inner face.

11. A gas turbine engine, comprising:
a tubing system that circulates a fluid;
a manifold in fluid communication with a portion of said tubing system; and
a tube fitting mounted to said manifold, said tube fitting including a housing and a tee fitting integrated with said housing to form a monolithic structure.

12. The gas turbine engine as recited in claim 11, wherein said tubing system circulates at least one of airflow, fuel and lubricant.

13. The gas turbine engine as recited in claim 11, wherein said tee fitting includes at least a first tube fitting connection and a second tube fitting connection.

14. The gas turbine engine as recited in claim 13, wherein said tubing system includes a first tube portion connected to said first tube fitting connection and a second tube portion connected with said second tube fitting connection.

15. The gas turbine engine as recited in claim 11, wherein said housing includes an inner face and an outer face, said inner face mounted to said manifold and said tee fitting protruding from said outer face.

16. A method of providing a tube fitting for connecting tubing, comprising:
integrating a housing and a tee fitting to provide a tube fitting having a monolithic structure.

17. The method as recited in claim 16, comprising:
mounting the tube fitting to a manifold of a tubing system.

18. The method as recited in claim 17, comprising:
connecting at least two tube portions to the tube fitting.

19. The method as recited in claim 18, comprising:
communicating fluid in either direction between the at least two tube portions, the tube fitting, and the manifold.
